(19) United States
(12) Patent Application Publication
(10) Pub. No.: US 2026/0011956 A1
(43) Pub. Date: Jan. 8, 2026

(54) Floating Terminal Assembly, Female Connector, and Floating Connection Device

(71) Applicant: Shanghai Space Appliance Co., Ltd., Putuo District, Shanghai (CN)

(72) Inventors: Xu WANG, Shanghai (CN); Jian WANG, Shanghai (CN); Zimin ZHANG, Shanghai (CN); Jun WANG, Shanghai (CN); Zhilin CHEN, Shanghai (CN)

(21) Appl. No.: 18/992,856

(22) PCT Filed: Jul. 11, 2023
(86) PCT No.: PCT/CN2023/106719

§ 371 Date: Jan. 9, 2025

(30) Foreign Application Priority Data
May 18, 2023 (CN) 202310567805.3

(51) Int. Cl. H01R 13/631

(52) U.S. Cl. CPC H01R 13/6315

(57) ABSTRACT

In one aspect, a floating terminal assembly includes a floating terminal, a first protruding finger, and a second protruding finger. The floating terminal includes a fixing portion, a floating bending portion, and an electrically abutting portion that are sequentially connected. The fixing portion and the floating bending portion cooperatively enclose a first floating opening region. The floating bending portion includes a plurality of bending corner structures. The first protruding finger is positioned in the first floating opening region, one end of the first protruding finger is connected to the fixing portion, and another end of the first protruding finger is suspended in the first floating opening region. An inter-capacitance zone is formed between the first protruding finger and the second protruding finger.

### CROSS-REFERENCE

This application claims priority to Chinese patent application No. 2023105678053 filed on May 18, 2023, entitled “FLOATING TERMINAL ASSEMBLY, FEMALE CONNECTOR, AND FLOATING CONNECTOR DEVICE”, the content of which is hereby incorporated by reference in its entirety.

### TECHNICAL FIELD

The present disclosure relates to the technical field of electrical connections, and in particular to a floating terminal assembly, a female connector, and a floating connector device.

### BACKGROUND

The floating connector device includes a female connector and a male connector. The female connector is connected to the male connector by floating insertion to realize the electrical connection therebetween. For high-frequency signal transmission, although the conventional floating connector device can ensure the floating performance between connectors, the floating terminal has high inductance due to floating in the air, so that the inductive reactance generated by the terminal in the signal transmission process is high.

### SUMMARY

According to various embodiments of the present disclosure, a floating terminal assembly, a female connector, and a floating connector device are provided.

In a first aspect, the present disclosure provides a floating terminal assembly, including:
a floating terminal including a fixing portion, a floating bending portion, and an electrically abutting portion that are sequentially connected, wherein the fixing portion and the floating bending portion cooperatively enclose a first floating opening region, the floating bending portion includes a plurality of bending corner structures and a plurality of linear connecting portions, adjacent two floating bending portions are connected through one linear connecting portion, and adjacent two linear connecting portions are connected through one floating bending portion;
a first protruding finger positioned in the first floating opening region, wherein one end of the first protruding finger is connected to the fixing portion, and another end of the first protruding finger is suspended in the first floating opening region; and
a second protruding finger positioned in the first floating opening region, wherein one end of the second protruding finger is connected to the floating bending portion, another end of the second protruding finger is suspended in the first floating opening region. and an inter-capacitance zone is formed between the first protruding finger and the second protruding finger.

In an embodiment, the first protruding finger and the second protruding finger are parallel to each other.

In an embodiment, the electrically abutting portion and the floating bending portion cooperatively enclose a second floating opening region, and the second floating opening region and the first floating opening region are positioned on two sides of the floating bending portion, respectively.

In an embodiment, the floating terminal assembly further includes a third protruding finger and a fourth protruding finger. One end of the third protruding finger is connected to a side of the floating bending portion away from the second protruding finger, and another end of the third protruding finger is suspended in the second floating opening region. One end of the fourth protruding finger is connected to the electrically abutting portion, and another end of the fourth protruding finger is suspended in the second floating opening region. The third protruding finger and the fourth protruding finger are both positioned in the second floating opening region, and the third protruding finger and the fourth protruding finger are arranged alternately with each other.

In an embodiment, the floating terminal assembly. the first protruding finger, the second protruding finger, the third protruding finger, and the fourth protruding finger are integrally formed as one-piece material structure.

In an embodiment, the third protruding finger and the fourth protruding finger satisfy one of the following conditions:
a width of the third protruding finger is equal to a width of the fourth protruding finger;
a minimum gap between the third protruding finger and the fourth protruding finger is equal to the width of the third protruding finger;
the minimum gap between the third protruding finger and the fourth protruding finger is not equal to the width of the third protruding finger;
the width of the third protruding finger is equal to the width of the fourth protruding finger, and the minimum gap between the third protruding finger and the fourth protruding finger is equal to the width of the third protruding finger; and
the width of the third protruding finger is equal to the width of the fourth protruding finger, and the minimum gap between the third protruding finger and the fourth protruding finger is not equal to the width of the third protruding finger.

In an embodiment, the first protruding finger and the second protruding finger satisfy one of the following conditions:
a width of the first protruding finger is equal to a width of the second protruding finger;
a minimum gap between the first protruding finger and the second protruding finger is equal to the width of the first protruding finger;
the minimum gap between the first protruding finger and the second protruding finger is not equal to the width of the first protruding finger;
the width of the first protruding finger is equal to the width of the second protruding finger, and the minimum gap between the first protruding finger and the second protruding finger is equal to the width of the first protruding finger; and
the width of the first protruding finger is equal to the width of the second protruding finger, and the minimum gap between the first protruding finger and the second protruding finger is not equal to the width of the first protruding finger.

In an embodiment, the first protruding finger satisfies one of the following conditions: the first protruding finger is in a rectangular shape, and the first protruding finger is in an arc shape;
the second protruding finger satisfies one of the following conditions: the second protruding finger is in a rectangular shape, and the second protruding finger is in an arc shape.

In a second aspect, the present disclosure provides a female connector including a female base, a floating socket, and at least two floating terminal assemblies as described in any one of the above embodiments. The female base forms a first inserting slot and an accommodating groove that are in communication with each other. The floating socket is positioned in the accommodating groove. Two sides of the floating socket are provided with two second inserting slots, respectively.

The fixing portion of the floating terminal of one floating terminal assembly is engaged into the first inserting slot, and the electrically abutting portion of the floating terminal of the one floating terminal assembly is engaged into one second inserting slot. The fixing portion of the floating terminal of another floating terminal assembly is engaged into the first inserting slot, and the electrically abutting portion of the floating terminal of the another floating terminal assembly is engaged into another second inserting slot.

In a third aspect, the present disclosure provides a floating connector device including a male connector and the female connector as described in the above. The male connector includes a male base and at least two male connecting terminals. The at least two male connecting terminals are respectively disposed on two sides of the male base. The male base inserted into the floating socket. One male connecting terminal slidably abuts against the electrically abutting portion of the floating terminal of one floating terminal assembly. Another male connecting terminal slidably abuts against the electrically abutting portion of the floating terminal of another floating terminal assembly.

Details of one or more embodiments of the present disclosure are set forth in the accompanying drawings and description below. Other features, objects, and advantages of the present disclosure will become apparent from the description, accompanying drawings, and claims.

### BRIEF DESCRIPTION OF THE DRAWINGS

To illustrate the technical solutions in the embodiments of the present disclosure or in the prior art more clearly, the accompanying drawings for describing the embodiments or the prior art are introduced briefly below in the following. Apparently, the accompanying drawings in the following description are only some embodiments of the present disclosure, and persons of ordinary skill in the art can derive other drawings from the accompanying drawings without creative efforts.

FIG. 1 is a schematic view of a floating terminal assembly according to an embodiment of the present disclosure.

FIG. 1a is a schematic view of the floating terminal assembly shown in FIG. 1 from another perspective.

FIG. 2 shows an equivalent circuit diagram of a longitudinal interdigital structure according to an embodiment of the present disclosure.

FIG. 3 shows a simplified equivalent circuit diagram of the longitudinal interdigital structure shown in FIG. 2.

FIG. 4 shows a schematic diagram of an equivalent circuit model of an electric-conducting terminal according to an embodiment of the present disclosure.

FIG. 5 shows a simplified equivalent circuit diagram corresponding to the circuit model shown in FIG. 4.

FIG. 6 shows a schematic graph of the impedance curves produced by a non-interdigital or interdigital structure of the electric-conducting terminal shown in FIG. 4.

FIG. 7 shows a simplified equivalent circuit diagram of an equivalent circuit model of an electric-conducting terminal with an interdigital structure according to an embodiment of the present disclosure.

FIG. 8 shows an exploded schematic diagram of a floating connector device according to an embodiment of the present disclosure.

FIG. 9 is a schematic view of a female connector of the floating connector device shown in FIG. 8.

FIG. 10 is a schematic view of a male connector of the floating connector device shown in FIG. 8.

### DETAILED DESCRIPTION

The embodiments of the present disclosure will be described in detail below, in order to make the above objects, features and advantages of the present disclosure more apparent and understandable. Numerous specific details are set forth in the following description in order to facilitate a thorough understanding of the present disclosure. However, the present disclosure can be implemented in many other ways than those describe herein, and similar modifications can be made by those skilled in the art without departing from the concept of the present disclosure, and thus the present disclosure is not limited to the embodiments disclosed below.

In the description of the present disclosure, it should be understood that, the orientation or position relationships indicated by the terms “central”, “longitudinal”, “transverse”, “length”, “width”, “thickness”, “upper”, “lower”, “front”, “back”, “left”, “right”, “vertical”, “horizontal”, “top”, “bottom”, “inner”, “outer”, “clockwise”, “counterclockwise”, “axial”, “radial”, “circumferential”, and the like are based on the orientation or position relationships shown in the accompanying drawings and are intended to facilitate the description of the present disclosure and simplify the description only, rather than indicating or implying that the apparatus or element referred to must have a particular orientation or be constructed and operated in a particular orientation, and therefore are not to be interpreted as limiting the present disclosure.

In the description of the present disclosure, the terms “first” and “second” are used for descriptive purposes only, and cannot be construed as indicating or implying a relative importance, or implicitly specifying the number of the indicated technical features. Thus, the feature defined with “first” or “second” may explicitly or implicitly include one or more features. In the description of the present disclosure, “a plurality of” means two or more, such as two or three, unless otherwise defined explicitly and specifically.

In the present disclosure, unless otherwise specified and defined explicitly, the terms “install”, “connect”, “join”, and “fix” should be understood in a broad sense. For example, unless otherwise defined explicitly, they may refer to a fixed connection, a detachable connection, or an integral connection, may refer to a mechanical connection or electrical connection, and may refer to a direct connection, an indirect connection via an intermediate medium, an internal connection between two elements, or interaction between two elements. Those of ordinary skill in the art can understand specific meanings of these terms in the present disclosure based on specific circumstances.

In the present disclosure, unless otherwise specified and defined explicitly, the expression a first feature being “on” or “under” a second feature may be the case that the first feature is in direct contact with the second feature, or the first feature is in indirect contact with the second feature via an intermediate medium. Furthermore, the first feature being “over”, “above” or “on top of” the second feature may be the case that the first feature is directly above or obliquely above the second feature, or only means that the level of the first feature is higher than that of the second feature. The first feature being “below”, “underneath” or “under” the second feature may be the case that the first feature is directly underneath or obliquely underneath the second feature, or only means that the level of the first feature is lower than that of the second feature.

It should be noted that when one element is referred to as “fixed to” or “arranged on” another element, it may be directly disposed on the other element or an intermediate element may exist. When one element is considered to be “connected to” another element, it may be directly connected to the other element or an intermediate element may co-exist. The terms “vertical”, “horizontal”, “upper”, “lower”, “left”, “right” and similar expressions used herein are for illustrative purposes only and do not represent the only implementation.

The present disclosure provides a floating terminal assembly. The floating terminal assembly satisfies at least one of the following conditions:
The floating terminal assembly includes a floating terminal, a first protruding finger, and a second protruding finger;
the floating terminal includes a fixing portion, a floating bending portion, and an electrically abutting portion that are sequentially connected;
the fixing portion and the floating bending portion cooperatively enclose a first floating opening region;
the floating bending portion includes a plurality of bending corner structures;
the first protruding finger is positioned in the first floating opening region;
an end of the first protruding finger is connected to the fixing portion;
the other end of the first protruding finger is suspended in the first floating opening region;
the second protruding finger is positioned in the first floating opening region;
an end of the second protruding finger is connected to the floating bending portion;
the other end of the second protruding finger is suspended in the first floating opening region; and
an inter-capacitance zone is formed between the first protruding finger and the second protruding finger.

In the above-described floating terminal assembly, the floating terminal includes the fixing portion, the floating bending portion, and the electrically abutting portion that are sequentially connected. The floating bending portion includes a plurality of bending corner structures, and the fixing portion and the floating bending portion cooperatively enclose the first floating opening region. As such, the floating terminal assembly has desirable floating performances and relatively high inductive reactance. Moreover, the first protruding finger and the second protruding finger are positioned in the first floating opening region. An end of the first protruding finger is connected to the fixing portion, and the other end of the first protruding finger is suspended in the first floating opening region. An end of the second protruding finger is connected to the floating bending portion, and the other end of the second protruding finger is suspended in the first floating opening region. The inter-capacitance zone is formed between the first protruding finger and the second protruding finger, so that the first floating opening region forms an interdigital structure, and the interdigital structure produces interdigital capacitance, better neutralizing the inductive reactance generated by the floating bending portion, thereby enabling the floating terminal assembly not only to have a desirable floating performance, but also to well reach a preset target value of the inductive reactance thereof. In other words, the signal transmission of the floating terminal assembly is more reliable.

In order to better understand the technical solutions and beneficial effects of the present disclosure, the present disclosure will be further described in detail below with reference to specific embodiments.

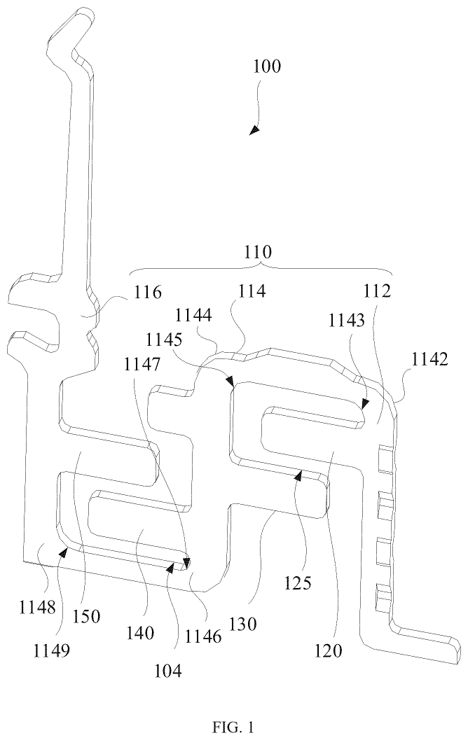

As shown in FIG. 1 and FIG. 1a, a floating terminal assembly 100 of an embodiment includes a floating terminal 110, a first protruding finger 120, and a second protruding finger 130. The floating terminal 110 includes a fixing portion 112, a floating bending portion 114, and an electrically abutting portion 116 that are sequentially connected. The fixing portion 112 and the floating bending portion 114 cooperatively enclose a first floating opening region 102. The floating bending portion 114 includes a plurality of bending corner structures 114a.

As shown in FIG. 1 and FIG. 1a, in an embodiment, the first protruding finger 120 is positioned in the first floating opening region 102. One end of the first protruding finger 120 is connected to the fixing portion 112, and the other end of the first protruding finger 120 is suspended in the first floating opening region 102. The second protruding finger is positioned in the first floating opening region 102. One end of the second protruding finger 130 is connected to the floating bending portion 114, and the other end of the second protruding finger 130 is suspended in the first floating opening region 102. An inter-capacitance zone is formed between the first protruding finger 120 and the second protruding finger 130, so that an interdigital gap is formed between the first protruding finger 120 and the second protruding finger 130. In this embodiment, the first protruding finger 120 and the second protruding finger 130 are arranged alternately, such that the interdigital gap 125 is formed between the end of the first protruding finger 120 suspended in the first floating opening region 102 and the end of the second protruding finger 130 suspended in the first floating opening region 102.

In the above-described floating terminal assembly 100, the floating terminal 110 includes the fixing portion 112, the floating bending portion 114, and the electrically abutting portion 116 that are sequentially connected. The floating bending portion 114 includes a plurality of bending corner structures 114a, and the fixing portion 112 and the floating bending portion 114 cooperatively enclose the first floating opening region 102. As such, the floating terminal assembly 100 has improved floating performances and relatively high inductive reactance. Moreover, the first protruding finger 120 and the second protruding finger 130 are positioned in the first floating opening region 102. One end of the first protruding finger 120 is connected to the fixing portion 112, and the other end of the first protruding finger 120 is suspended in the first floating opening region 102. One end of the second protruding finger 130 is connected to the floating bending portion 114, and the other end of the second protruding finger 130 is suspended in the first floating opening region 102. The inter-capacitance zone is formed between the first protruding finger 120 and the second protruding finger 130, so that the first floating opening region 102 forms an interdigital structure, and the interdigital structure produces interdigital capacitance, better neutralizing the inductive reactance generated by the floating bending portion 114, thereby enabling the floating terminal assembly 100 not only to have an improved floating performance, but also to well reach a preset target value of the inductive reactance thereof. In other words, the signal transmission of the floating terminal assembly is more reliable.

It should be noted that, as shown in FIG. 1a, in an embodiment, the first protruding finger 120 is positioned in the first floating opening region 102. One end of the first protruding finger 120 is connected to the fixing portion 112, and the other end of the first protruding finger 120 is suspended in the first floating opening region 102. The second protruding finger 130 is positioned in the first floating opening region 102. One end of the second protruding finger 130 is connected to the floating bending portion 114, and the other end of the second protruding finger 130 is suspended in the first floating opening region 102. The inter-capacitance zone is formed between the first protruding finger 120 and the second protruding finger 130, so that the interdigital gap is formed between the first protruding finger 120 and the second protruding finger 130. The first protruding finger 120 and the second protruding finger 130 cooperatively form the interdigital structure of the floating terminal assembly 100, i.e., a longitudinal interdigital structure.

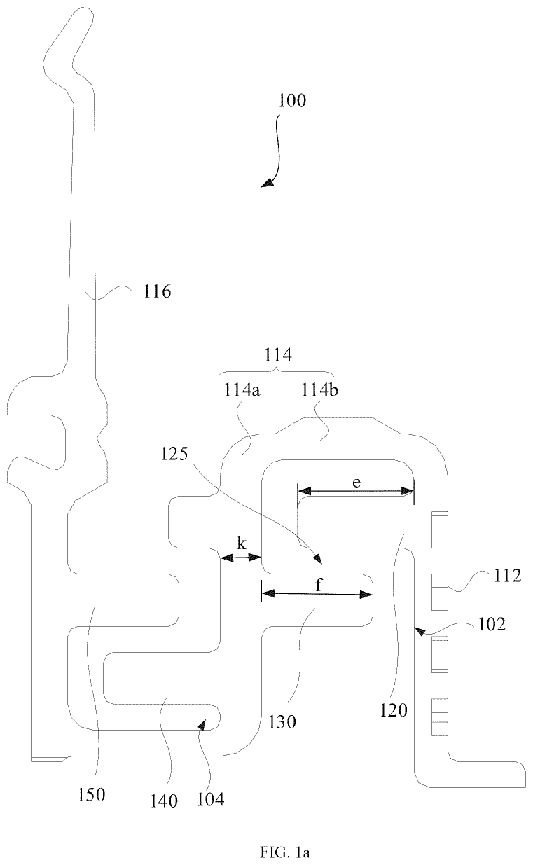

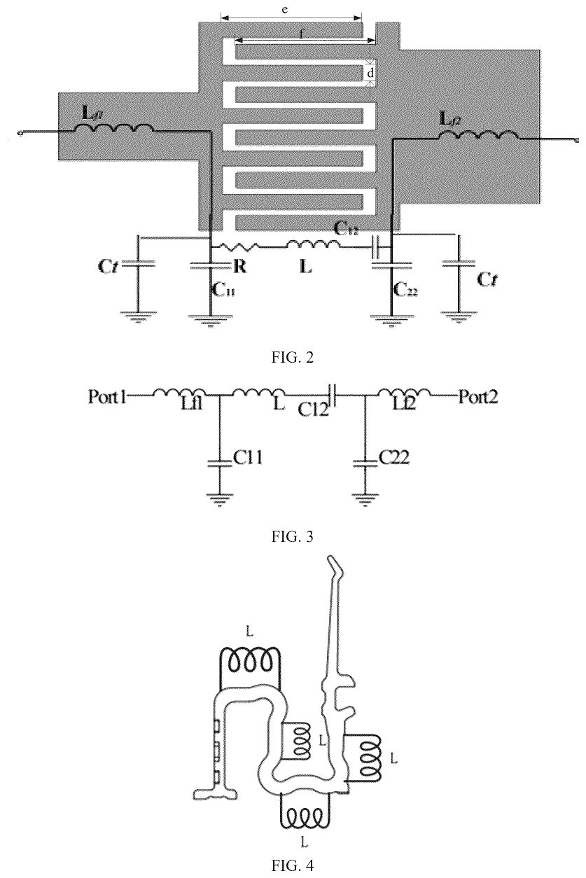

Further, FIG. 2 shows an equivalent circuit diagram of a longitudinal interdigital structure. The fixing portion 112 and the floating bending portion 114 can be equivalent to the feeders on both sides of the longitudinal interdigital structure, respectively. L_{f1} and L_{f2} represent inductances of the two feeders, that is, the inductance corresponding to the fixing portion 112 is represented as L_{f1}, and the inductance corresponding to the floating bending portion 114 is represented as L_{f2}. Ct represents capacitance-to-ground of the terminal line. C₁₁ represents capacitance-to-ground of the first protruding finger 120, that is, the capacitance-to-ground of the left interdigital piece. C₂₂ represents capacitance-to-ground of the second protruding finger 130, that is, the capacitance-to-ground of the right interdigital piece. R represents resistance of the interdigital piece. L represents inductance of the interdigital piece, and C₁₂ represents the interdigital capacitance of the interdigital piece. Cₜ can be combined with C₁₁ and C₂₂, respectively.

Assuming that the floating terminal is made of a lossless material, R is negligible, and a simplified equivalent circuit diagram as shown in FIG. 3 can be obtained. According to the simplified equivalent circuit, it can be inferred that the longitudinal interdigital structure is a band-pass model. C₁₂ in the equivalent circuit is equal to the value of the interdigital capacitance of the interdigital piece

As shown in FIGS. 1a and 2, under the condition of a limited thickness dielectric plate with the thickness much larger than an interdigital width as well as the interdigital gap 125. In an embodiment, when the interdigital width is equal to the interdigital gap 125, the formula for calculating C₁₂ is as follows:

$$C ( p F ) = 3.937 \times 1 {0}^{- 5} l ( {ε}_{r} + 1 ) [ 0.11 ( n - 3 ) + 0.252 ]$$

where n represents the number of the interdigital piece, l represents a length of the interdigital piece in unit of mm, and ϵᵣ represents a dielectric constant of the dielectric plate. In an embodiment, the dielectric plate is a plate base for mounting a floating terminal assembly.

In an embodiment, when the interdigital width is not equal to the gap, the formula for calculating C₁₂ is as follows:

$$C ( p F ) = ( {ε}_{r} + 1 ) \{ 10.5 {( W / G )}^{0.3} + 0.3523 ( n - 3 ) [ 5.5452 - 8 ln ( tan \frac{π G}{4 ( G + W )} - tan {\frac{π G}{4 ( G + W )}}^{4} ] \} l$$

where G represents a constant coefficient, and W represents an interdigital width.

It can be seen from the above two formulas that, the interdigital capacitance C₁₂ has an increasing relationship with the interdigital length, and the interdigital capacitance C₁₂ has a decreasing relationship with the interdigital gap. As shown in FIGS. 1a and 2, the interdigital length represents the length e of the first protruding finger 120 or the length f of the second protruding finger 130. In this embodiment, the length e of the first protruding finger 120 is equal to the length f of the second protruding finger 130, and both are equal to l.

For linear transmission of signals, the formulas for calculating the resulting linear inductance are as follows:

$$L ( nH ) = 2 \times {10}^{- 4} [ ln ( \frac{l}{W + t} ) + 1.193 + 0.2235 \frac{W + t}{l} ] {K}_{g} ;$$

$${K}_{g} = 0.57 - 0.145 ln \frac{W}{h} ; \frac{W}{h} > 0.05 ;$$

where l represents a linear length in unit of μm, w represents a linear width; t represents a metal thickness, i.e., a terminal thickness, and h represents a thickness of the dielectric plate. It can be seen from the above formulas that the linear inductance L (nH) decreases with the increase of the line width w and increases with the increase of the line length l.

Similarly, the above-described formula for calculating the linear inductance is equally applicable to the inductance of the longitudinal interdigital structure. When applied to calculate the inductance of the longitudinal interdigital structure, l represents the interdigital length, and w represents the interdigital width. Similarly, it can be determined that the inductance of the longitudinal interdigital structure decreases with the increase of the interdigital width, and increases with the increase of the interdigital length. However, for the floating terminal assembly having the longitudinal interdigital structure, the value of the inductance of the longitudinal interdigital structure, i.e., the value of the interdigital inductance, is so small that it can be ignored.

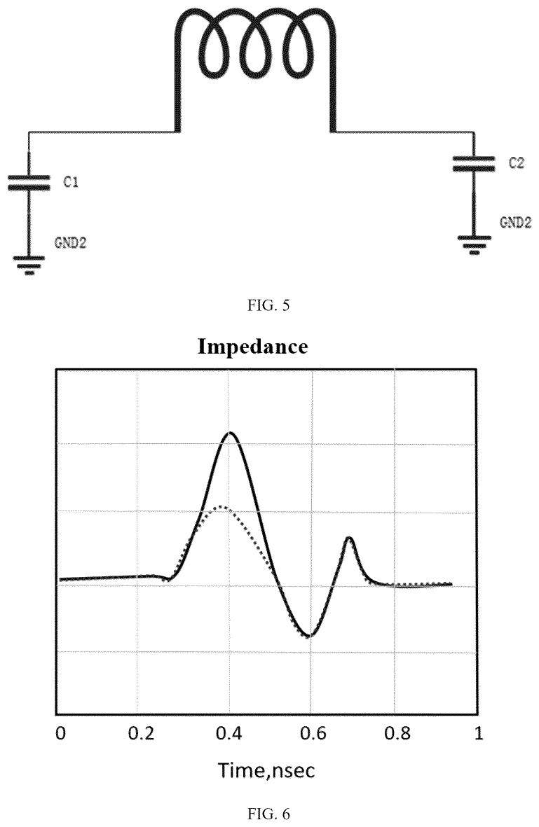

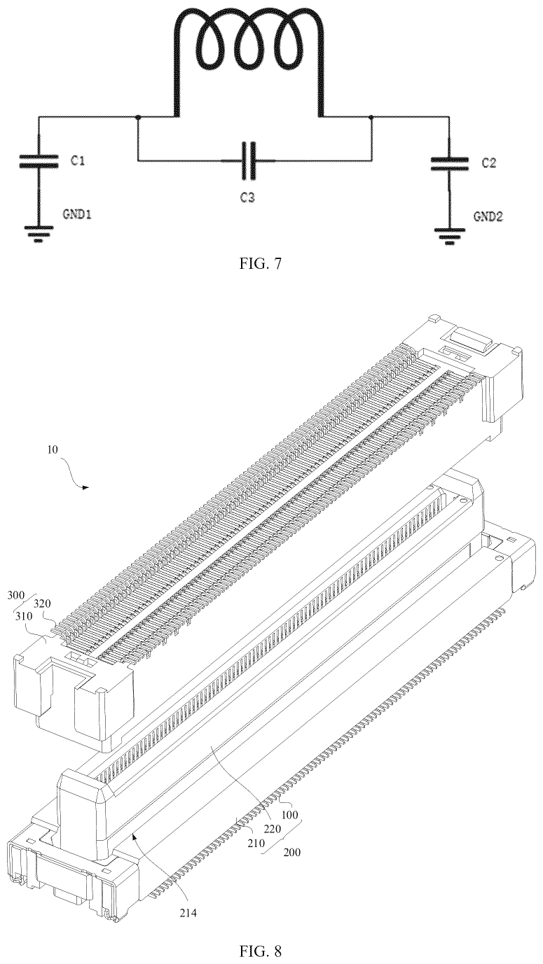

As shown in FIG. 1a, the floating bending portion 114 of the above-described floating terminal assembly 100 includes a plurality of bending corner structures 114a, and the fixing portion 112 and the floating bending portion 114 cooperatively enclose the first floating opening region 102, so that the floating terminal assembly 100 is suspended in the air, thereby enabling the floating terminal assembly 100 to form more linear connecting structures. For example, at least one linear connecting structure is formed between adjacent two bending corner structures 114a, as shown in FIG. 1. In this embodiment, the fixing portion 112 and the floating bending portion 114 of the floating terminal assembly 100 cooperatively enclose the first floating opening region 102. It can be understood that in a certain space between the fixing portion 112 and the electrically abutting portion 116, the floating bending portion 114 has a greater linear length than that of a conventional terminal structure, so that the floating bending portion 114 of the floating terminal assembly 100 has a relatively large sum of linear inductances, and thus the floating terminal assembly 100 has a relatively large sum of linear inductances, the equivalent model of which is shown in FIG. 4, and the corresponding simplified equivalent circuit diagram is shown in FIG. 5. As such, the floating terminal assembly 100 can have an improved floating performance and a relatively high inductive reactance, and the impedance curve produced correspondingly is represented by the solid line shown in FIG. 6. Moreover, the interdigital structure is formed in the first floating opening region 102. and the inter-capacitance zone is formed between the first protruding finger 120 and the second protruding finger 130, so that the interdigital structure of the floating terminal assembly 100 can form an interdigital capacitance. Combined with the above analysis, the interdigital structure mainly exhibits capacitance characteristics. The corresponding simplified equivalent circuit diagram is shown in FIG. 7, and the corresponding generated impedance curve is represented by the dotted line shown in FIG. 6. According to the comparison of impedance curves during terminal signal transmission shown in FIG. 6, it can be understood that the inductive reactance value of a single inductance can be reduced by disposing interdigital capacitance at two ends of the inductance in parallel; that is, the interdigital structure of the floating terminal assembly 100 can neutralize the inductive reactance. In this way, the overall inductive reactance value of the floating terminal assembly 100 can be reduced to a preset value. As shown in FIG. 6, the peak value of the dashed line shown in is significantly lower than the peak value of the solid line, so that the floating terminal assembly 100 not only has an improved floating performance, but also well reach the preset target value of the inductive reactance thereof. In other words, the signal transmission of the floating terminal assembly 100 is more reliable.

Referring again to FIG. 1a, in an embodiment. the floating bending portion 114 further includes a plurality of linear connecting portions 114b. Adjacent two floating bending portions 114 are connected through one linear connecting portion 114b, so that adjacent two linear connecting portions 114b of the floating bending portion are spaced apart. Compared with the conventional terminal structure, in a certain space between the fixing portion 112 and the electrically abutting portion 116, the floating bending portion 114 has a greater linear length; that is, the number of linear connecting portions 114b formed is larger; that also is, the sum of linear inductances formed is larger. As such, the floating terminal assembly 100 has an improved floating performance and a relatively high inductive reactance, and meanwhile the inter-capacitance zone well is formed between the first protruding finger 120 and the second protruding finger 130 in the first floating opening region 102.

Referring again to FIG. 1, in an embodiment, the first protruding finger 120 and the second protruding finger 130 are parallel to each other.

Referring again to FIG. 1, in this embodiment, the number of the first protruding fingers 120 and the number of the second protruding fingers 130 are one. In other embodiments, the number of the first protruding fingers 120 and the number of the second protruding fingers 130 are not limited to one. For example, the number of the first protruding fingers 120 and the number of the second protruding fingers 130 are both two. Adjacent two first protruding fingers 120 are provided with one second protruding finger 130 therebetween, and adjacent two second protruding fingers 130 are provided with one first protruding finger 120 therebetween, so that the two first protruding fingers 120 and the two second protruding fingers 130 are spaced apart. It should be understood that in other embodiments, the number of first protruding fingers 120 is not limited to be equal to the number of second protruding fingers 130. For example, the number of first protruding fingers 120 is one more than the number of second protruding fingers 130. In another example, the number of first protruding fingers 120 is one less than the number of second protruding fingers 130.

Referring again to FIG. 1a, in an embodiment, the electrically abutting portion 116 and the floating bending portion 114 cooperatively enclose a second floating opening region 104. The second floating opening region 104 and the first floating opening region 102 are positioned on both sides of the floating bending portion 114, respectively. In this way, the structure of the floating terminal assembly 100 is more compact, and the floating terminal assembly 100 has an improved floating performance and a relatively high inductive reactance.

Referring again to FIG. 1a, in an embodiment, the floating terminal assembly 100 further includes a third protruding finger 140 and a fourth protruding finger 150. One end of the third protruding finger 140 is connected to a side of the floating bending portion 114 away from the second protruding finger 130, and the other end of the third protruding finger 140 is suspended in the second floating opening region 104. One end of the fourth protruding finger 150 is connected to the electrically abutting portion 116, and the other end of the fourth protruding finger 150 is suspended in the second floating opening region 104. The third protruding finger 140 and the fourth protruding finger 150 are both positioned in the second floating opening region 104. The third protruding finger 140 and the fourth protruding finger 150 are arranged alternately with each other. The electrically abutting portion 116 and the floating bending portion 114 cooperatively enclose the second floating opening region 104, so that the floating terminal assembly 100 has an improved floating performance and a relatively high inductive reactance. Moreover, the third protruding finger 140 and the fourth protruding finger 150 are arranged alternately with each other, so that the first floating opening region 102 and the second floating opening region 104 both form interdigital structures. Each interdigital structure can produce interdigital capacitance, better neutralizing the inductive reactance generated by the floating bending portion 114, thereby enabling the floating terminal assembly 100 not only to have an improved floating performance, but also to well reach a preset target value of the inductive reactance thereof, in other words, the signal transmission of the floating terminal assembly 100 is more reliable.

Referring again to FIG. 1a, in an embodiment, the floating terminal 110, the first protruding finger 120, the second protruding finger 130, the third protruding finger 140, and the fourth protruding finger 150 are integrally formed as one-piece material structure. As such, the floating terminal assembly 100 has a relatively low processing difficulty and a relatively compact structure, and the floating terminal 110, the first protruding finger 120, the second protruding finger 130, the third protruding finger 140, and the fourth protruding finger 150 are reliably and fixedly connected.

Referring again to FIG. 1a in an embodiment, the width of the first protruding finger 120 is equal to the width of the second protruding finger 130, so that the interdigital structure cooperatively formed by the first protruding finger 120 and the second protruding finger 130 has better interdigital capacitance.

Referring again to FIG. 1a, in an embodiment, the width of the third protruding finger 140 is equal to the width of the fourth protruding finger 150, so that the interdigital structure cooperatively formed by the third protruding finger 140 and the fourth protruding finger 150 has better interdigital capacitance.

Referring again to FIG. 1, in an embodiment, the minimum gap between the first protruding finger 120 and the second protruding finger 130 can be equal to or not equal to the width of the first protruding finger 120. In this embodiment, the minimum gap between the first protruding finger 120 and the second protruding finger 130 is equal to the width of the first protruding finger 120. In other embodiments, the minimum gap between the first protruding finger 120 and the second protruding finger 130 is not equal to the width of the first protruding finger 120. For example, the minimum gap between the first protruding finger 120 and the second protruding finger 130 is less than or greater than the width of the first protruding finger 120.

In an embodiment, the minimum gap between the third protruding finger 140 and the fourth protruding finger 150 can be equal to or not equal to the width of the third protruding finger 140. In this embodiment, the minimum gap between the third protruding finger 140 and the fourth protruding finger 150 is equal to the width of the third protruding finger 140. In other embodiments, the minimum gap between the third protruding finger 140 and the fourth protruding finger 150 is not equal to the width of the third protruding finger 140. For example, the minimum gap between the third protruding finger 140 and the fourth protruding finger 150 is less than or greater than the width of the third protruding finger 140.

Referring again to FIG. 1, in an embodiment, the first protruding finger 120 is in a rectangular or arc shape, such that it is easy to form the first protruding finger 120, while enabling to form the interdigital capacitance well. The second protruding finger 130 is in a rectangular or arc shape, such that it is easy to form the second protruding finger 130, while enabling to form the interdigital capacitance well.

Referring again to FIG. 1, further, the bending directions of the plurality of bending corner structures 114a are disposed differently. The plurality of bending corner structures are a first bending corner structure 1142, a second bending corner structure 1144, a third bending corner structure 1146, and a fourth bending corner structure 1148, respectively. The first bending corner structure 1142 forms a first bending groove 1143. The second bending corner structure 1144 forms a second bending groove 1145. The third bending corner structure 1146 forms a third bending groove 1147. The fourth bending corner structure 1148 forms with a fourth bending groove 1149. The first bending groove 1143 and the second bending groove 1145 are both in communication with the first floating opening region 102. The third bending groove 1147 and the fourth bending groove 1149 are both in communication with the second floating opening region 104.

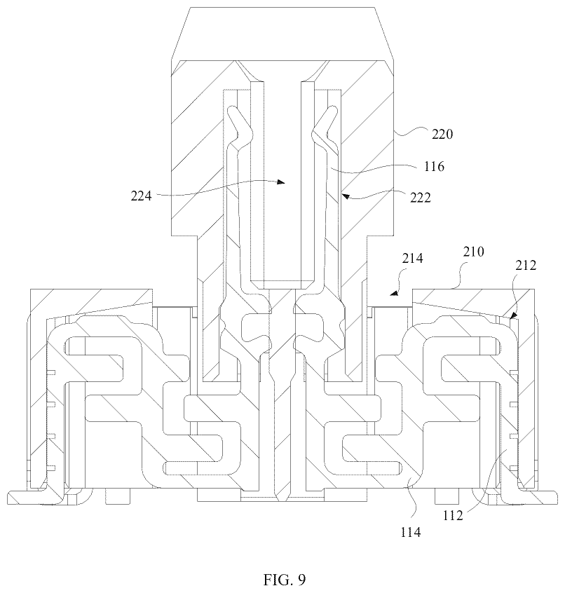

As shown in FIGS. 1, 8 and 9, the present disclosure also provides a female connector 200, including a female base 210, a floating socket 220 and at least two floating terminal assemblies 100 as described in any one of the above embodiments. The female base 210 forms a first inserting slot 212 and an accommodating groove 214 in communication with each other. The floating socket 220 is positioned in the accommodating groove 214 and is floated relative to the female base. Two second inserting slots 222 are provided on two sides of the floating socket 220, respectively. The fixing portion 112 of the floating terminal 110 of one floating terminal assembly 100 is engaged into the first inserting slot 212, and the electrically abutting portion 116 of the floating terminal 110 of the one floating terminal assembly 100 is engaged into one second inserting slot 222. The fixing portion 112 of the floating terminal 110 of another floating terminal assembly 100 is engaged into the first inserting slot 212, and the electrically abutting portion 116 of the floating terminal 110 of the another floating terminal assembly 100 is engaged into another second inserting slot 212. In this way, the floating socket 220 can float reliably relative to the female base 210, thereby enabling the female connector 200 to have an improved floating performance.

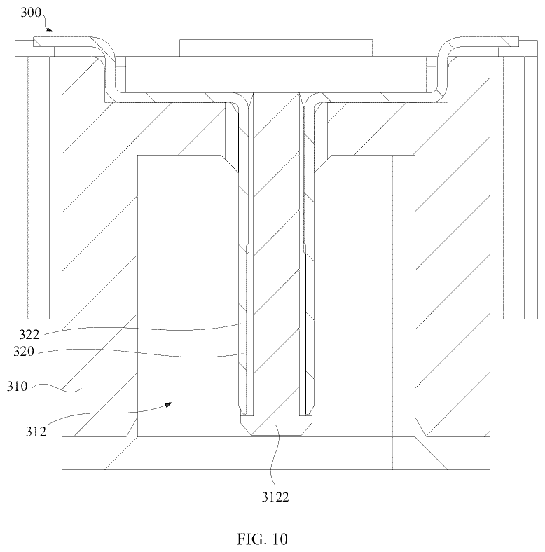

As shown in FIGS. 1, 8, and 9, the present disclosure provides a floating connector device 10, including a male connector 300 and the female connector 200 described above. Referring also to FIG. 10, the male connector 300 includes a male base 310 and at least two male connecting terminals 320. The at least two male connecting terminals 320 are disposed on two sides of the male base 310, respectively. The male base 310 is connected to the floating socket 220 by being inserted into the floating socket 220. One male connecting terminal 320 slidably abuts against the electrically abutting portion 116 of the floating terminal 110 of one floating terminal assembly 100. Another male connecting terminal 320 slidably abuts against the electrically abutting portion 116 of the floating terminal 110 of another floating terminal assembly 100. In this way, each male connecting terminal 320 is reliably electrically connected to the corresponding floating terminal assembly 100, thus achieving reliable floating transmission of signals. In this embodiment, the male connector 300 and the female connector 200 are connected to each other by floatable insertion into each other. The male base 310 and the floating socket 220 are connected to each other by floatable insertion into each other.

As shown in FIGS. 8 to 10, further, a first inter-inserting slot 312 is formed on a side of the male base 310 adjacent to the floating socket 220, and the first inter-inserting slot 312 is provided with an inserting tongue piece 3122 protruding therefrom. At least two male connecting terminals 320 are symmetrically disposed on the male base 310, and contacting exposed ends 322 of the at least two male connecting terminals 320 protrude from surfaces of both sides of inserting tongue pieces 3122, respectively. The floating socket 220 is formed with a second inter-inserting slot 224. The inserting tongue piece 3122 is engaged into the second inter-inserting slot 224, and the floating socket 220 is inserted into the first inter-inserting slot 312, so that the male base 310 and the floating socket 220 are connected to each other by inserting into each other. In this embodiment, the second inter-inserting slot 224 is in communication with two second inserting slots 222. The electrically abutting portion 116 of the floating terminal 110 of each floating terminal assembly 100 is engaged into a corresponding second inserting slot 222. A part of the electrically abutting portion 116 of the floating terminal 110 of the floating terminal assembly 100 is exposed in the second inter-inserting slot 224 and is in contact with the contacting exposed end 322 of the corresponding male connecting terminal 320, so that each floating terminal assembly 100 is electrically connected to a corresponding male connecting terminal 320.

Compared to the prior art, the present disclosure has at least the following advantages:

In the above-described floating terminal assembly 100, the floating terminal 110 includes the fixing portion 112, the floating bending portion 114, and the electrically abutting portion 116 that are sequentially connected. The floating bending portion 114 includes a plurality of bending corner structures 114a, and the fixing portion 112 and the floating bending portion 114 cooperatively enclose the first floating opening region 102. As such, the floating terminal assembly 100 has improved floating performances and relatively high inductive reactance. Moreover, the first protruding finger 120 and the second protruding finger 130 are positioned in the first floating opening region 102. An end of the first protruding finger 120 is connected to the fixing portion 112, and the other end of the first protruding finger 120 is suspended in the first floating opening region 102. An end of the second protruding finger 130 is connected to the floating bending portion 114, and the other end of the second protruding finger 130 is suspended in the first floating opening region 102. The inter-capacitance zone is formed between the first protruding finger 120 and the second protruding finger 130, so that the first floating opening region 102 forms an interdigital structure, and the interdigital structure produces interdigital capacitance, better neutralizing the inductive reactance generated by the floating bending portion 114, thereby enabling the floating terminal assembly 100 not only to have an improved floating performance, but also to well reach a preset target value of the inductive reactance thereof. In other words, the signal transmission of the floating terminal assembly is more reliable.

The technical features of the above-mentioned embodiments can be combined arbitrarily. In order to make the description concise, not all possible combinations of the technical features are described in the embodiments. However, as long as there is no contradiction in the combination of these technical features, the combinations should be considered as in the scope of the present disclosure.

The above-described embodiments are only several implementations of the present disclosure, and the descriptions are relatively specific and detailed, but they should not be construed as limiting the scope of the present disclosure. It should be understood by those of ordinary skill in the art that various modifications and improvements can be made without departing from the concept of the present disclosure, and all fall within the protection scope of the present disclosure. Therefore, the patent protection of the present disclosure shall be defined by the appended claims.

1. A floating terminal assembly, comprising:
a floating terminal comprising a fixing portion, a floating bending portion, and an electrically abutting portion that are sequentially connected, wherein the fixing portion and the floating bending portion cooperatively enclose a first floating opening region, the floating bending portion comprises a plurality of bending corner structures and a plurality of linear connecting portions, adjacent two floating bending portions are connected through one linear connecting portion, and adjacent two linear connecting portions are connected through one floating bending portion;
a first protruding finger positioned in the first floating opening region, wherein one end of the first protruding finger is connected to the fixing portion, and another end of the first protruding finger is suspended in the first floating opening region; and
a second protruding finger positioned in the first floating opening region, wherein one end of the second protruding finger is connected to the floating bending portion, another end of the second protruding finger is suspended in the first floating opening region, and an inter-capacitance zone is formed between the first protruding finger and the second protruding finger.

2. The floating terminal assembly according to claim 1, wherein the first protruding finger and the second protruding finger are parallel to each other.

3. The floating terminal assembly according to claim 1, wherein the electrically abutting portion and the floating bending portion cooperatively enclose a second floating opening region, the second floating opening region and the first floating opening region are positioned on two sides of the floating bending portion, respectively.

4. The floating terminal assembly according to claim 3, further comprising a third protruding finger and a fourth protruding finger, wherein one end of the third protruding finger is connected to a side of the floating bending portion away from the second protruding finger, another end of the third protruding finger is suspended in the second floating opening region, one end of the fourth protruding finger is connected to the electrically abutting portion, and another end of the fourth protruding finger is suspended in the second floating opening region, the third protruding finger and the fourth protruding finger are both positioned in the second floating opening region, and the third protruding finger and the fourth protruding finger are arranged alternately with each other.

5. The floating terminal assembly according to claim 4, wherein the floating terminal assembly, the first protruding finger, the second protruding finger, the third protruding finger, and the fourth protruding finger are integrally formed as one-piece material structure.

6. The floating terminal assembly according to claim 4, wherein the third protruding finger and the fourth protruding finger satisfy one of following conditions:
a width of the third protruding finger is equal to a width of the fourth protruding finger;
a minimum gap between the third protruding finger and the fourth protruding finger is equal to the width of the third protruding finger;
the minimum gap between the third protruding finger and the fourth protruding finger is not equal to the width of the third protruding finger;
the width of the third protruding finger is equal to the width of the fourth protruding finger, and the minimum gap between the third protruding finger and the fourth protruding finger is equal to the width of the third protruding finger; and
the width of the third protruding finger is equal to the width of the fourth protruding finger, and the minimum gap between the third protruding finger and the fourth protruding finger is not equal to the width of the third protruding finger.

7. The floating terminal assembly according to claim 1, wherein the first protruding finger and the second protruding finger satisfy one of following conditions:
a width of the first protruding finger is equal to a width of the second protruding finger;
a minimum gap between the first protruding finger and the second protruding finger is equal to the width of the first protruding finger;
the minimum gap between the first protruding finger and the second protruding finger is not equal to the width of the first protruding finger;
the width of the first protruding finger is equal to the width of the second protruding finger, and the minimum gap between the first protruding finger and the second protruding finger is equal to the width of the first protruding finger; and
the width of the first protruding finger is equal to the width of the second protruding finger, and the minimum gap between the first protruding finger and the second protruding finger is not equal to the width of the first protruding finger.

8. The floating terminal assembly according to claim 1, wherein the first protruding finger satisfies one of following conditions: the first protruding finger is in a rectangular shape, and
the first protruding finger is in an arc shape;
wherein the second protruding finger satisfies one of following conditions: the second protruding finger is in a rectangular shape, and the second protruding finger is in an arc shape.

9. A female connector, comprising a female base, a floating socket, and at least two floating terminal assemblies according to claim 1,
wherein the female base forms a first inserting slot and an accommodating groove that are in communication with each other, the floating socket is positioned in the accommodating groove, and two sides of the floating socket are provided with two second inserting slots, respectively;
wherein the fixing portion of the floating terminal of one floating terminal assembly is engaged into the first inserting slot, the electrically abutting portion of the floating terminal of the one floating terminal assembly is engaged into one second inserting slot; the fixing portion of the floating terminal of another floating terminal assembly is engaged into the first inserting slot, and the electrically abutting portion of the floating terminal of the another floating terminal assembly is engaged into another second inserting slot.

10. A floating connector device, comprising a male connector and the female connector according to claim 9, wherein the male connector comprises a male base and at least two male connecting terminals, the at least two male connecting terminals are disposed on two sides of the male base, respectively, the male base is inserted into the floating socket, one male connecting terminal slidably abuts against the electrically abutting portion of the floating terminal of one floating terminal assembly, and another male connecting terminal slidably abuts against the electrically abutting portion of the floating terminal of another floating terminal assembly.
